(19) United States
(12) Patent Application Publication
(10) Pub. No.: US 2026/0113659 A1
(43) Pub. Date: Apr. 23, 2026

(54) RADIO RESOURCE PARTITIONING BASED ON CONGESTION NOTIFICATION

(71) Applicant: T-MOBILE INNOVATIONS LLC, Overland Park, KS (US)

(72) Inventors: Timur Kochiev, Irvine, CA (US); Relin Thomas, Seattle, WA (US)

(21) Appl. No.: 18/922,756

(22) Filed: Oct. 22, 2024

(51) Int. Cl. H04W 28/02

(52) U.S. Cl. CPC H04W 28/0289; H04W 28/0247

(57) ABSTRACT

Systems, methods, and software are disclosed herein for allocating radio resources of an access node of a wireless communication network based on congestion notification in various implementations. In one example, a computing apparatus processes congestion notification data to detect a level of congestion in data traffic carried of a network slice by an access node of a wireless communication network. The computing apparatus determines that the level of congestion exceeds a threshold value for reallocating radio resources of the access node and reallocates the radio resources of the access node to provide additional carrying capacity for the data traffic of the network slice based on determining that the level of congestion exceeds the threshold value.

### TECHNICAL FIELD

Aspects of the disclosure are related to the field of wireless communication networks, particularly management of network data traffic and radio resources of access nodes.

### BACKGROUND

In wireless network communications, excessive traffic congestion can lead to excess latency, buffer bloat, and packet loss, where packets are dropped to signal congestion to the sender. Network congestion is particularly detrimental to transmissions associated with time-critical applications such as VoIP (voice over IP), videoconferencing, live streaming, online gaming, and other types of traffic which rely on low latency and low packet loss to provide a high-quality user experience. For example, in cloud gaming and augmented/virtual reality (AR/VR) applications, network congestion can lead to jitter and freezing which degrades the user experience. Conventional efforts to detect congestion within the network infrastructure include detecting excessive packet loss, monitoring network latency, tracking bandwidth utilization, and analyzing patterns of retransmissions.

To address the challenges to speed and reliability of time-critical data transmission, Low Latency, Low Loss, Scalable Throughput (L4S) technology enables traffic management to reduce congestion build-up, thereby reducing the detrimental effects of congestion on transmission. L4S relies on an extension of the Internet Protocol (IP) defining Explicit Congestion Notification (ECN) by which network traffic can be marked in such a way as to signal to ECN-enabled senders to reduce their transmission rates to alleviate a congestion build-up, rather than dropping packets to signal the build-up to a sender. More specifically, when an ECN-aware router detects that traffic congestion is exceeding a traffic congestion threshold, the router marks the IP header of a packet queued at the router to indicate “Congestion Experienced.” This mark, when received at an ECN-aware endpoint, causes the endpoint to echo the congestion indication back to the ECN-aware sender, which in turn causes the sender to reduce its transmission rate. By reducing the transmission rate, congestion is alleviated, resulting in reduced packet loss and improved latency.

### OVERVIEW

Technology is disclosed herein for allocating radio resources of an access node of a wireless communication network based on congestion notification in various implementations. In one example, a computing apparatus comprises one or more computer readable storage media, one or more processors operatively coupled with the one or more computer readable storage media and program instructions stored on the one or more computer readable storage media that, when executed by the one or more processors, direct the computing apparatus to process congestion data to detect a level of congestion in data traffic carried of a network slice by an access node of a wireless communication network; determine that the level of congestion exceeds a threshold value for reallocating radio resources of the access node; and reallocate the radio resources of the access node to provide additional carrying capacity for the data traffic of the network slice based on determining that the level of congestion exceeds the threshold value.

In another example, a method of operating a computing device comprises processing congestion data to detect a level of congestion in data traffic of a network slice carried by an access node of a wireless communication network; determining that the level of congestion exceeds a threshold value for reallocating the radio resources of the access node; and partitioning the radio resources of the access node to provide additional carrying capacity for the data traffic of the network slice based on determining that the level of congestion exceeds the threshold value.

In yet another example of the technology disclosed herein, a computing apparatus comprises one or more computer readable storage media, one or more processors operatively coupled with the one or more computer readable storage media and program instructions stored on the one or more computer readable storage media that, when executed by the one or more processors, direct the computing apparatus to detect congestion data for data traffic of network slices carried by an access node of a wireless communication network; determine, based on the congestion data, that a level of congestion for a network slice of the network slices exceeds a threshold value; and partition radio resources of the access node to the network slices based on determining that the level of congestion exceeds the threshold value.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for radio resource partitioning based on congestion notification in an implementation.

FIG. 2 illustrates a process for radio resource allocation based on congestion notification in an implementation.

FIG. 3 illustrates an operational environment for radio resource allocation based on congestion notification in an implementation.

FIGS. 4A and 4B illustrate workflows for radio resource allocation based on congestion notification in an implementation.

FIG. 5 illustrates an operational architecture of a wireless communication network supporting radio resource allocation based on congestion notification in an implementation.

FIG. 6 illustrates a computing system suitable for implementing the various operational environments, architectures, processes, scenarios, and sequences discussed below with respect to the other Figures.

### DETAILED DESCRIPTION

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

In the field of wireless communication networks, network resources are allocated according to multiple virtual networks or network slices which are tailored to support different types of network data traffic, such as fixed wireless access (FWA), enhanced mobile broadband (eMBB), ultra-reliable low latency communications (URLLC), massive machine type communications (mMTC), massive Internet of Things communications (mIoT), vehicle to everything communications (V2X), and so on. Network resources for each type of network slice may be configured according to the performance parameters of the respective Quality of Service (QoS) requirements. These parameters can include bandwidth, latency, jitter, packet loss, throughput, and availability. These parameters may be implemented at different layers of the Open Systems Interconnection (OSI) model, a framework for conceptualizing network protocols for the control and data/user planes of network data traffic. In operation, radio access nodes (RANs) carrying data traffic for a wireless communication network may allocate their radio resources according to the slice type of the traffic constituents. For example, a RAN may allocate or partition 70% of its available radio resources to the data traffic for eMBB and 30% to FWA traffic in accordance with the QoS for each slice. An access node of the network may dynamically reallocate radio resources amongst the various network slices based on changing demand for network services.

When congestion arises on a wireless network, the congestion can degrade the user experience for users who may be engaged in streaming high-definition video or using videoconferencing applications, VR/XR applications, or other bandwidth-intensive activities. In a simple illustration, when congestion arises in eMBB data traffic, the congestion may manifest at the physical and transport layers of the network. At the physical layer, physical resource blocks (PRBs) are depleted due to the high demand leading to packet delay or packet loss. At the transport layer, the network detects congestion in the form of packet loss and responsively modifies the flow of data by reducing transmission rates and, as a result, reduced throughput among other effects. For eMBB users, the reduced transmission rate can result in lower video quality, buffering, slower downloads, and so on—ultimately, a degraded user experience. Moreover, with the reduced transmission rate, the eMBB traffic may be switched to a lower Modulation and Coding Scheme (MCS), a more robust technique for transmitting the data but one which consumes more PRB resources, thereby exacerbating the PRB depletion.

In contrast, according to various implementations of the technology disclosed herein, information received by the RAN relating to ECN bits embedded in the IP headers of the data packets can be used by the RAN to detect congestion in data traffic hosted by the RAN. When congestion notifications are detected in the ECN bits of data traffic for various slices hosted by the RAN, the RAN can reallocate its radio resources amongst the slices to satisfy the increased demand. Referring to the illustration above, when the congestion arises on eMBB data traffic, the RAN detects ECN congestion notifications originating from within the RAN which indicates that the eMBB data traffic is experiencing congestion or increased demand. In response to detecting the ECN congestion notifications, the RAN can reduce the radio resource partitioning of another slice such as FWA traffic to, say, 20% from 30% so that additional carrying capacity (e.g., bandwidth) can be allocated to the eMBB traffic. By doing so, the reallocation accommodates the increase in the eMBB traffic load in satisfaction of the eMBB QoS requirements while avoiding the increase in PRB congestion. Similarly, if the RAN detects an increase in congestion in FWA traffic based on ECN detection in the FWA traffic carried by the RAN, the RAN can reapportion its radio resources to provide additional capacity to the FWA traffic and in doing so decreasing such capacity for traffic of one or more other slices.

Various implementations are disclosed herein for allocating radio resources based on congestion notifications embedded in data traffic hosted by an access node. In various implementations, an access node such as a gNodeB, cell, or base station of a wireless communication network responds to changing network conditions based on detecting congestion using ECN technology. In an exemplary scenario, the access node monitors congestion via ECN congestion notification markings made by one or more devices on the access node across the data traffic of multiple network slices hosted by the access node. The access node balances radio resource allocations amongst the network slices according to the traffic loading or congestion that is detected for each of the slices. In response to detecting ECN congestion notifications in data traffic for the various slices, the access node can prioritize its radio resource allocation to provide more resources for higher-priority, resource-intensive data traffic (e.g., eMBB traffic, URLLC traffic) over lower-priority traffic (e.g., FWA traffic). Prioritization of data traffic for partitioning radio resources may be based on 5G QoS Identifier (5QI) priority levels of the network slices. Allocating radio resources may include reallocating a portion of bandwidth from the lower-priority traffic to the bandwidth-intensive traffic to maintain the more demanding QoS requirements of such traffic. To provide additional bandwidth to the higher-priority traffic of a given network slice, the data link or MAC layer of the network which controls the flow of data on the network allocates greater PRB capacity to the traffic of the given slice.

In some scenarios, detecting congestion in network data traffic of an access node includes generating and monitoring ECN data, such as a metric which quantifies detected ECN bits or which quantifies a rate of change in detected ECN bits. The ECN metric may be compared to a threshold value such that when the metric exceeds the threshold, the access node reallocates radio resources to provide additional carrying capacity for congested traffic. When the ECN metric returns to a nominal value (e.g., falls below the threshold), the original resource allocation may be restored. In some scenarios, the partitioning of radio resources may be continually modulated according to the ECN metric, such as adjusting the allocation in favor of a given slice undergoing an increase in congestion and decreasing the allocation for the slice to a baseline allocation when the congestion subsides.

In some implementations, the network (e.g., an access node of the network) executes a machine learning (ML) or artificial intelligence (AI) model, such as an artificial neural network, which has been trained to predict data traffic behavior including network congestion based on historical information of ECN usage at a given access node according to variables such as day, time, application, network slice, and/or radio resource partitioning. When the trained model is executed, the model may be used to anticipate periods of increased traffic loading or congestion by which the access node can reallocate its radio resources to maintain service. Alternatively, the trained model may recommend an allocation profile of the radio resources according to network slice type based on the input data in accordance with its training. For example, the model may be trained to return a bandwidth allocation for the various network slices based on the input data. In still other scenarios, the model may be trained to return a threshold value such that an ECN metric exceeding the threshold would trigger a reallocation of radio resources. In any case, the access node can proactively repartition radio resources between network slices according to the congestion detected on the network. For example, the access node may allocate bandwidth between (traffic of) a lower-demand slice and (traffic of) a higher-demand slice based on the output of the model to maintain transmission quality for higher-demand traffic, particular when the network slice for the higher-demand traffic has a higher priority level or more stringent QoS standards than the lower-demand slice.

As an artificial neural network model, to generate the desired output, the trained AI model may be a regression model which returns, for example, a congestion level or which recommends an apportionment or distribution of radio resources based on the input data. The input data may include ECN data and corresponding contextual information (day, time, region, slice type, QoS requirements, etc.). Alternatively, the trained AI model may be a classification model which returns an indication of whether to initiate a reallocation to apportion more of the radio resources to a higher-priority or congested network slice, such as apportioning more bandwidth of the RAN to the data traffic of the congested slice. The input data to the AI model may be configured as a feature or input vector (i.e., a data structure comprising data values organized in an array, the values of which are accessible by an index corresponding to each position in the array) which is processed by the input, hidden, and output layers of the model to compute an output value in accordance with its training.

Technical effects of the technology disclosed herein include rapid reallocation of radio resources of an access node among network slice traffic which allows the access node to more rapidly adapt to changing traffic conditions such as increasing congestion. By reallocating radio resources amongst the network slices based on ECN detection, the access node can rapidly respond to the changing conditions by prioritizing certain types of traffic to receive a greater allocation of radio resources, such as bandwidth, to maintain the applicable QoS while also avoiding worsening the congestion based on reducing transmission rates. Beyond enabling rapid response to changing traffic load conditions, the technology can also be used to predict traffic conditions based on historical ECN data and to proactively respond to current conditions or predicted future conditions based on the historical data.

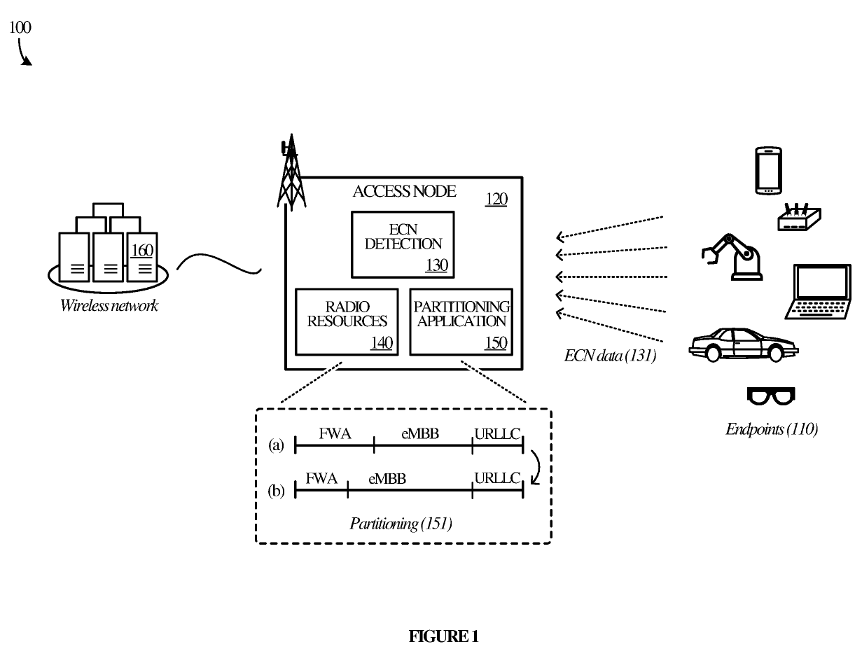

Turning now to the Figures, FIG. 1 illustrates operational environment 100 for radio resource partitioning based on congestion notification in an implementation. Operational environment 100 includes wireless network 160 in communication with access node 120 and endpoints 110. Access node 120 includes ECN detection 130, radio resources 140, and partitioning application 150 by which radio resources of access node 120 are allocated to network slices hosted by access node 120.

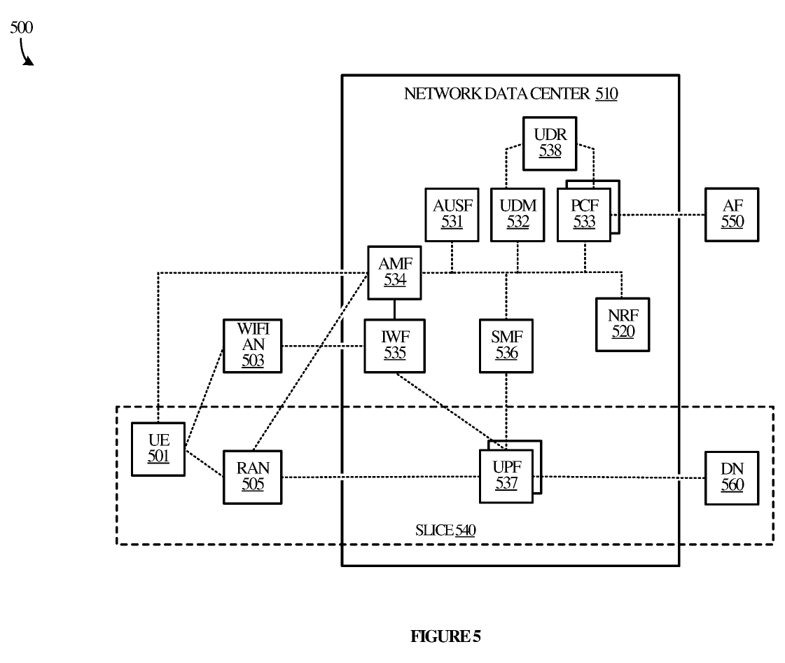

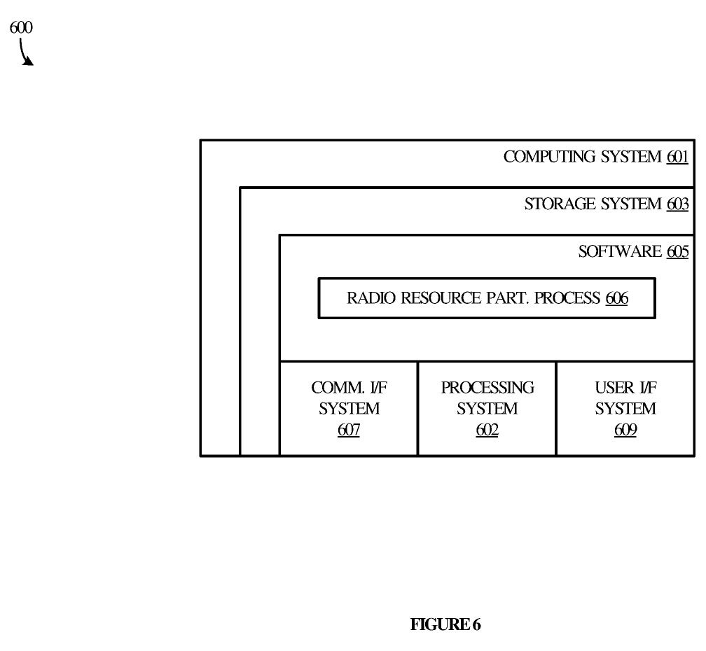

Wireless network 160 is representative of a communication network capable of using a Fifth Generation New Radio (5G-NR), 4G LTE, 6G, or other protocol to communicate with L4S-enabled or ECN-enabled devices such as endpoints 110. In an implementation, wireless network 160 is representative of a service-based architecture (SBA) which includes network functions which constitute the control plane and user plane of a wireless communication network core, of which network data center 510 of FIG. 5 is representative. The network functions of wireless network 160 are implemented on one or more suitable computing devices, of which computing device 601 of FIG. 6 is representative. Examples of suitable computing devices include server computers, blade servers, and the like. The network elements of wireless network 160 may be implemented in the context of one or more data centers in a co-located or distributed manner, or in some other arrangement.

Access node 120 is representative of equipment, such as cells or base stations or gNodeBs of Fifth Generation (5G) RANs, access nodes of long-term evolution (LTE) RANs, eNodeBs, macrocells, NB-IoT access nodes, LP-WAN base stations, wireless relays, Wifi access nodes, and/or other wireless or wireline network transceivers. Access node 120 hosts access networks using radio frequencies to provide wireless network connectivity to devices. To communicate with a network core of wireless network 160, access node 120 includes receiving unit (RU) circuitry which communicates along fronthaul data paths to distributed unit (DU) circuitry which in turn communicates with central unit (CU) circuitry along midhaul data paths. Although illustrated as a tower, access node 120 may include other physical configurations, including rooftop installations, small-cell sites, distributed antenna systems, vehicle-mounted systems, airborne access nodes, and so on.

ECN detection 130 of access node 120 is representative of a functionality implemented in hardware or software to identify ECN data 131 of transmissions to/from endpoints 110 according to the type of communication or network slice. ECN detection 130 generates one or more metrics which quantify the ECN bits detected in transmissions from endpoints 110 or the rate of change of the detected ECN bits in transmissions associated with endpoints 110. For example, for a given network slice, ECN detection 130 may generate a metric which indicates the number of ECN bits detected in transmissions associated with endpoints 110 as a percentage of all transmissions for a given period of time. Alternatively, ECN detection 130 may generate a rate of change in the number of ECN bits that are detected in transmissions associated with endpoints 110 for a given slice over a given period of time.

Radio resources 140 is representative of a functionality implemented in hardware or software of access node 120 to host communication links of endpoints 110 to various destinations (not shown). Radio resources 140 may include bandwidth or PRB allocations, beamforming allocations, transmission power allocations, carrier frequency allocations, and MCS allocations to data traffic according to network slice.

Partitioning application 150 of access node 120 is representative of a functionality implemented in hardware or software by which access node 120 determines an allocation of radio resources 140 for data traffic according to network slice, such as data traffic to/from endpoints 110 in communication with access node 120. In various implementations, partitioning application 150 receives input data from ECN detection 130 based on ECN data 131. ECN data 131 is indicative of network congestion from endpoints 110, and partitioning application 150 determines a resource allocation for the network slices hosted by access node 120 for endpoints 110. A highly simplified depiction of resource partitioning is illustrated as partitioning 151 in FIG. 1 for FWA, eMBB, and URLLC slice traffic.

In some implementations, partitioning application 150 includes a functionality for projecting network congestion for the various network slices hosted by access node 120 according to a day, time, and location. For example, partitioning application 150 may include an AI model or generative AI model trained based on data from historical ECN data to return a projected level of network congestion of the various network slices supported by the access node at a given day, time, and location. Based on the projections of congestion returned by the model, access node 120 may partition radio resources 140 to maintain the QoS for the various network slices.

Endpoints 110 are representative of L4S-enabled or ECN-enabled devices, such as smartphones or other mobile devices, laptop or desktop computers, Internet of Things (IoT) devices, wearable devices, routers, smart vehicles, robots, sensors, controllers, augmented or virtual reality devices, and the like, of which computing system 601 in FIG. 6 is broadly representative. Endpoints 110 include processing circuitry for wireless communication with access node 120 of wireless network 160 using protocols such as Fifth Generation New Radio (5G-NR), 5G Advanced, 4G/LTE, 6G, Institute of Electrical and Electronic Engineers (IEEE) 802.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). Endpoints 110 exchange wireless communication signals with access nodes such as access node 120 of wireless network 160 over radio frequency bands. Endpoints 110 also include functionality by which to signal or respond to network congestion conditions using ECN bits, transmitting ECN data 131 to access node 120.

In a brief operational scenario of operational environment 100, endpoints 110 are in communication with access node 120 including sending and receiving data carried by wireless network 160 to/from endpoints (not shown) such as user equipment, cloud-based destinations such as application servers, web servers, etc. For the sake of illustration, it will be assumed that radio resources supporting communication between access node 120 and endpoints 110 includes a bandwidth allocation (a) depicted of partitioning 151.

Continuing with the operational scenario, ECN detection 130 detects a change in ECN data comprising an increase in the number of ECN bits signaling congestion in data packet headers transiting access node 120 for the eMMB network slice. In response to the quantity of ECN bits signaling congestion exceeding a threshold value, partitioning application 150 determines that access node 120 should reallocate bandwidth capacity to decrease the bandwidth allocation to FWA traffic and to increase the bandwidth allocation for eMBB traffic, as depicted in bandwidth allocation (b) of partitioning 151. ECN detection 130 may also determine that congestion notifications of URLLC traffic has not exceed a respective threshold, and therefore the bandwidth allocation for the URLLC slice is to remain unchanged.

ECN detection 130 continues to monitor conditions which could affect data transmission to determine the most appropriate radio resource allocation for the various types of slice traffic. When ECN detection 130 detects that the number of congestion-signaling ECN bits originating from access node 120 has fallen below the threshold, partitioning application 150 may again reallocate radio resources 140 to optimize transmission conditions or to maintain network performance with respect to QoS requirements for various kinds of slice traffic.

In various implementations, radio resources 140 are modulated according to the level of network congestion detected by ECN detection 130. For example, bandwidth partitioning among the slices may be periodically or continuously adjusted to maintain network performance based on the level of network congestion indicated by ECN data 131 for each of the slices. Continuous or periodic modulation may allow access node 120 to respond more rapidly to changing network conditions enabling access node 120 to optimize the deployment of its resources.

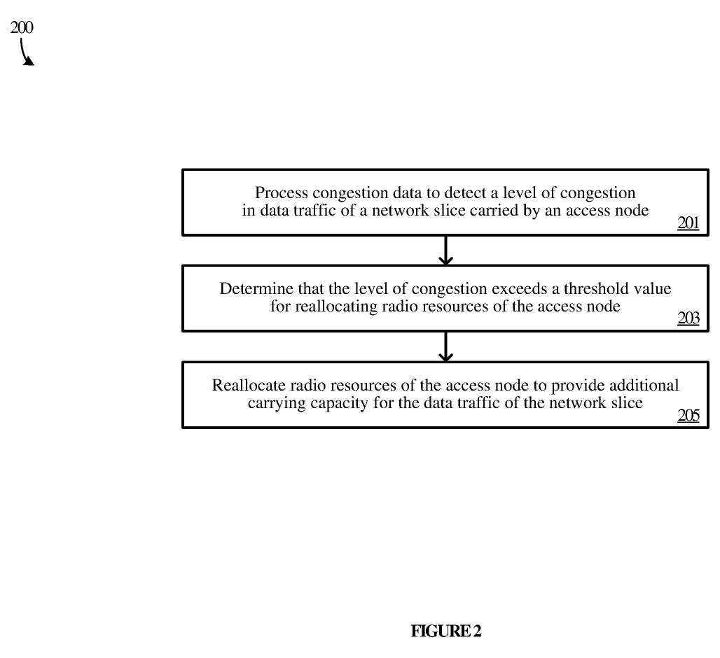

FIG. 2 illustrates a method for radio resource allocation based on congestion notification in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

In process 200, a computing device processes congestion data to detect a level of congestion in data traffic of a network slice carried by an access node of a wireless communication network (step 201). In an implementation, a computing device processes ECN-enabled data traffic of a network slice to detect ECN data indicating congestion in data traffic transiting the access node. The access node may host data traffic of communication paths to/from various endpoints based on configuring allocations of its radio resources according to the type of traffic (i.e., type of network slice of the traffic). In various implementations, the computing device monitors congestion or traffic loading across the various network slices hosted by the access node based on the ECN data detected according to the network slice. For example, if the computing device detects an increase in the quantity of ECN congestion notifications of the ECN data for a given network slice, the computing device determines that there is an increase in the level of congestion in the data traffic for the given slice.

To generate the ECN data, such as generating one or more metrics which quantify ECN bit markings or ECN congestion notifications, in an implementation, the computing device reads packet headers of data packets transiting the base station to extract ECN bit values embedded in the headers. The ECN bit values may be set in the IP header of a data packet by an ECN-aware router or other device of the access node along the communication path of the data packet. ECN-enabled devices at either end of the communication path can read ECN bit values and respond accordingly. For example, if an ECN-aware router marks a packet header to indicate that there is a build-up of network congestion, the ECN-enabled device at the receiving end may respond by downgrading its transmission bitrate and echoing the congestion indication to the sending device (via the ECN-Echo (ECE) flag) in the TCP header of an acknowledgement packet so it can also downgrade its transmission bitrate. By downgrading the bitrate, the congestion build-up may be slowed or even mitigated for network data traffic. To mark the packet, the ECN-aware router sets the rightmost bits of the Traffic Class of the IP header to a value which indicates whether the packet is ECN-enabled and whether congestion has been experienced. For example, ECN bit values of “01” or “10” indicates that the packet is ECN-enabled; “11” indicates that the packet is ECN-enabled and that the router has experienced network congestion. Bit values of “00” indicate the packet is not ECN-enabled.

The computing device determines that the level of congestion exceeds a threshold value for reallocating radio resources of the access node (step 203). In an implementation, for a given slice, as ECN-capable packets transit the computing device, the computing device tracks a quantity of the packet headers which include an ECN congestion notification which indicates that congestion has been experienced at a point or queue along the communication path. For example, the computing device may track the quantity of packets which include congestion-signaling ECN bits (e.g., “11” bits) relative to all of the ECN-enabled packets for a specified period of time (e.g., a percentage). Alternatively, the computing device may track the quantity of ECN-enabled packets signaling congestion detected over a specified period of time, such as a rate of congestion-signaling bits per hour. For the given slice, the computing device determines that an actionable level of network congestion has occurred for the slice traffic when the quantity of congestion-signaling ECN bits exceeds a threshold value. In some cases, the computing device may track the rate at which it receives packets signaling congestion relative to all ECN-enabled packets; when the rate exceeds a threshold value, the computing device determines that an actionable level of network congestion has been reached. In some implementations, the computing device may adjust the distribution of radio resources (e.g., bandwidth) according to the levels of congestion detected for the various network slices. The distribution of radio resources may be continually adjusted based on incoming ECN data. In some scenarios, the threshold value may depend on the type of network slice for which congestion is detected. For example, the threshold value of a slice may be set higher or lower than those of other slices to vary the level of congestion which may be tolerated in the respective data traffic.

In some scenarios, packet header data including the ECN data may be fed to an artificial intelligence (AI) model that has been trained to detect or analyze network congestion based on patterns arising in a data stream of packet header and contextual information. For example, the AI model may be an artificial neural network which has been trained on historical ECN data along with corresponding day, time, geographic location, transmission bitrate, and slice type data. The historical ECN data may be correlated to congestion classifications (e.g., congested or not congested) or to congestion regression values (e.g., a level or quantity of congestion). Subsequent to training, the model may be used to determine whether congestion is occurring or a level of network congestion according to the type of network slice based on recent or current data captured by the computing device.

The computing device reallocates the radio resources of the access node to provide additional carrying capacity for the data traffic of the network slice in response to determining that the level of congestion exceeds the threshold value (step 205). In an implementation, upon determining that a particular level of network congestion has been reached or is occurring in the traffic of one or more network slices, the computing device evaluates and allocates its carrying capacity for the various types of slice traffic hosted by the access node. For example, the computing device may evaluate the radio resources for FWA and eMBB data traffic currently being supported by the access node and determine that based on a rise in congestion of the eMBB traffic, more bandwidth should be allocated to eMBB traffic while bandwidth allocated to FWA traffic can be reduced without significant impact to the service provided for that traffic. The determinations of whether and how to reallocate the radio resources amongst the various kinds of slice traffic may also be based on the traffic loading (e.g., level of ECN congestion detection) experienced on other network slices and the QoS requirements for the network slices including 5QI priority levels of the network slices. Moreover, the extent of the radio resource reallocation may vary depending on the amount of congestion detected from the ECN-enabled data traffic. For example, should the detected congestion become severe, the computing device may reallocate the radio resources more aggressively to maintain network performance for the congested traffic.

In some scenarios, an AI model may be trained to determine a radio resource allocation (e.g., a bandwidth allocation) for the various slices hosted by the access node based on the level of congestion detected for the slices. For example, as ECN bits indicating congestion are detected, the computing device may configure an input vector of the ECN data for processing by a trained machine learning model which determines an optimal resource allocation for the various slices (e.g., an allocation distribution or profile) in accordance with its training. Other inputs provided to the model for processing may include contextual information (day, time, geographic region, etc.) along with QoS parameters of the supported slices. As above, the machine learning model may be trained based on historical ECN data along with corresponding contextual information, QoS parameters, etc.

Having reallocated the radio resources of the access node amongst the various network slices in response to the heightened congestion, the computing device may continue to monitor the congestion based on the ECN data including congestion notifications originating within the node and reallocate radio resources in response to changes in the network congestion.

Referring again to FIG. 1, operational environment 100 illustrates a brief example of process 200 as employed by elements of operational environment 100. In operation, ECN detection 130 executed by access node 120 processes ECN data 131 of slice traffic of endpoints 110 for which access node 120 is hosting service to detect congestion which may be occurring in the data traffic of the various slices. Endpoints 110 represent ECN-enabled devices; ECN detection 130 receives ECN data 131 from the data packet headers for transmission to/from the devices. Based on ECN data 131, ECN detection 130 detects a level of network congestion for eMMB traffic, such as detecting a higher than usual rate of congestion-signaling ECN bits in the ECN data of the eMMB traffic.

Upon determining that the level of network congestion has exceeded a congestion threshold (such as a congestion threshold specified for eMMB traffic), partitioning application 150 determines an allocation of radio resources of access node 120 for the various network slices. For example, in response to the detected congestion, partitioning application 150 may determine that the bandwidth provisioned for eMBB data traffic should be increased in response to the congestion signaling. Partitioning application 150 may also determine that the bandwidth provisioned for FWA data traffic is to be decreased. As illustrated in partitioning 151, partitioning application 150 may change the current bandwidth allocation (a) of radio resources 140 to a new bandwidth allocation (b). Subsequent to a reallocation, should network congestion return to a nominal level (e.g., fall below the congestion threshold), partitioning application 150 may reallocate radio resources 140 to a previous (e.g., default) state.

In an alternative exemplary scenario of operational environment 100, as ECN detection 130 continually receives ECN data 131 and quantifies network congestion based on ECN data 131, access node 120 may determine that it is appropriate for the current allocation to continue and that a reallocation is not necessary.

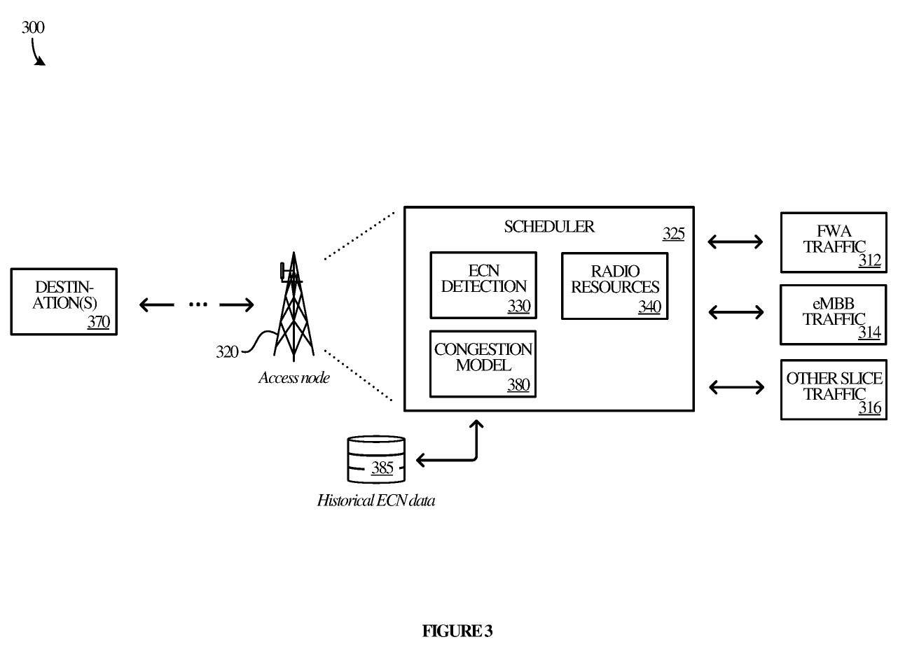

Turning now to FIG. 3, FIG. 3 illustrates operational environment 300 for allocating radio resources based on congestion notifications of ECN data traffic in an implementation. Operational environment 300 includes access node 360 hosting data traffic such as FWA traffic 312, eMBB traffic 314, and other slice traffic 316 for communication links to various destinations of destinations 370. (For ease of description, the following description refers to allocating radio resources among two network slices, FWA and eMMB; however, it may be appreciated that methods described herein are applicable to allocating radio resources amongst three or more network slices with no loss of generality). Access node 320 includes scheduler 325 which in turn includes ECN detection 330, radio resources 340, and congestion model 380. Congestion model 380 is trained based on historical ECN data 385.

Access node 320 is representative of equipment, such as access nodes of Fifth Generation (5G) radio access networks (RANs), access nodes of long-term evolution (LTE) RANs, gNodeBs, eNodeBs, macrocells, NB-IoT access nodes, LP-WAN base stations, wireless relays, Wifi access nodes, and/or other wireless or wireline network transceivers. Access node 320 hosts network data traffic of a wireless network (not shown) using radio frequencies to provide wireless network connectivity to devices such as endpoints 110 of FIG. 1. To communicate with a network core of the wireless network, cells or base stations such as access node 320 include receiving unit (RU) circuitry which communicates along fronthaul data paths to distributed unit (DU) circuitry which in turn communicates with central unit (CU) circuitry along midhaul data paths. Although illustrated as a tower, access node 320 may include other physical configurations, including rooftop installations, small-cell sites, distributed antenna systems, vehicle-mounted systems, airborne access nodes, and so on.

Access node 320 includes scheduler 325 which is representative of a functionality implemented in hardware or software which performs tasks relating to resource allocation including allocation of radio resources 340. Scheduler 365 may also perform tasks relating to QoS management, traffic load balancing, and power control. Scheduler 365 may include in some implementations congestion model 380 for predicting network congestion and which has been trained using historical ECN data 385.

Congestion model 380 is representative of a functionality of access node 320 implemented in hardware or software by which scheduler 325 predicts network congestion based on historical congestion data including historical ECN data 385. In some implementations, congestion model 380 is a trained AI model, such as an artificial neural network, which receives input including ECN data from data traffic such as FWA traffic 312 or eMBB traffic 314 as well as contextual information such as time, day, and location of historical network congestion events, and information relating to the type or source of data traffic or network slices associated with historical congestion events.

FWA traffic 312, eMBB traffic 314, and other slice traffic 316 are representative of network data traffic hosted by access node 320 of a wireless network to communicate with various communication endpoints of destinations 370. FWA traffic 312 is hosted by an allocation of network resources including radio resources 340 of access node 320 according to QoS requirements for FWA traffic. Similarly, eMBB traffic 314 is hosted by an allocation of network resources including radio resources 340 of access node 320 according to QoS requirements for eMBB traffic. FWA traffic 312, eMBB traffic 314, and other slice traffic 316 can include ECN-enabled traffic by which ECN detection 330 monitors network congestion along communication links hosted by the wireless network including access node 320.

Destinations 370 are representative of endpoints of communication path carrying network data traffic, such as FWA traffic 312, eMBB traffic 314, and other slice traffic 316, hosted by access node 320 of a wireless communication network. Destinations 370 can include user equipment (UEs), data networks, cloud-based destinations such as web servers or application servers, and the like. Destinations 370 can include, for example, an application server hosting a time-critical application or application for real-time communication, such as videoconferencing, online gaming, AR/VR, or live streaming applications.

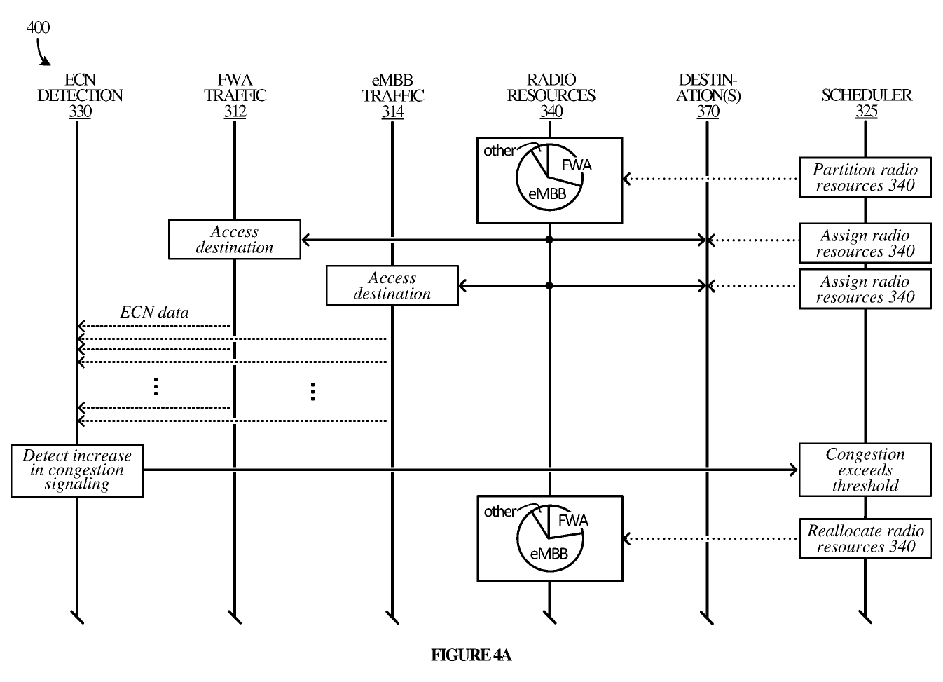

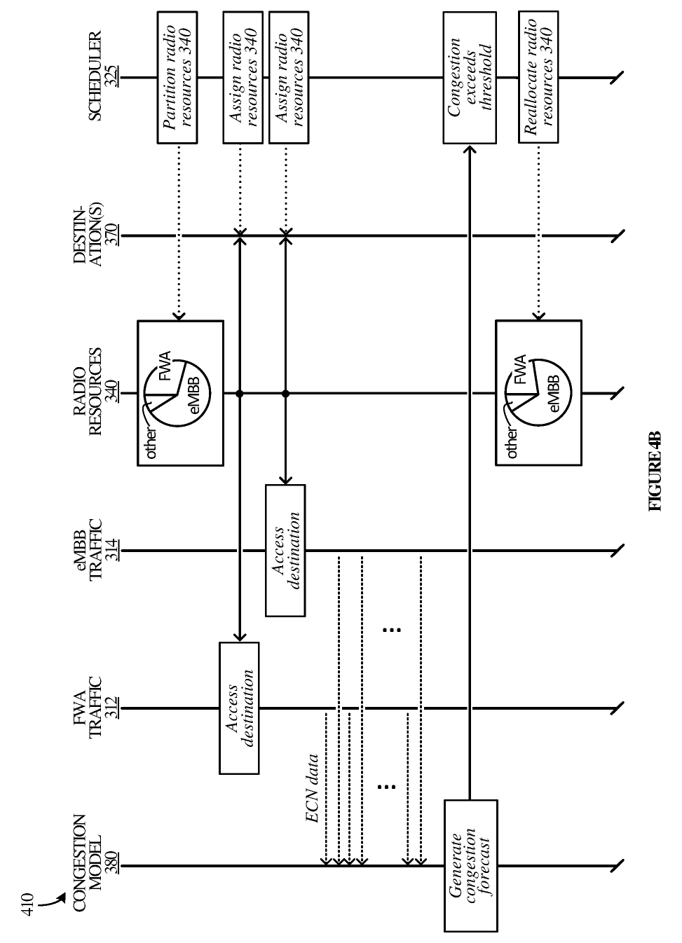

FIGS. 4A and 4B illustrate workflows 400 and 410 employed in illustrations of allocating radio resources based on congestion notifications of ECN data traffic in an implementation, referring to elements of operational environment 300. In workflow 400, radio resources 340 of access node 320 are allocated by scheduler 325 to support data traffic of various types of network slices, such as FWA traffic 312, eMBB traffic 314, and other slice traffic 316. As devices (not shown) establish communication links with various endpoints of destinations 370, radio resources 340 are apportioned by scheduler 325 to support those communication links according to the type of data traffic, e.g., FWA, eMBB, etc., being carried.

In workflow 400, as data traffic is carried by access node 320, ECN detection 330 continually receives ECN data from the data traffic for the various slices and evaluates network congestion in the slice traffic based on the ECN data. For the sake of illustration, it will be assumed that ECN detection 330 has determined that network congestion has increased or is increasing for eMBB traffic 314. When ECN detection 330 detects a heightened level of congestion-signaling ECN bits in the eMBB data traffic, ECN detection 330 signals scheduler 325 which determines that the level or quantity of ECN bits detected or network congestion for the eMBB slice has exceeded a threshold for triggering a reallocation of radio resources 340. In response to detecting the heightened level of congestion notifications in the ECN data (and inferring a heightened level of congestion based on the detection), scheduler 325 determines a new allocation of radio resources 340 to maintain network performance requirements of the various types of slice traffic. As illustrated, scheduler 325 determines to increase the allocation of radio resources 340 to eMBB traffic 314 from FWA traffic 312. The reallocation determined by scheduler 325 may increase the bandwidth capacity of radio resources 340 to eMBB traffic 314 while decreasing the bandwidth to FWA traffic 312. (It may be assumed for the sake of illustration that the allocation of radio resources 340 to other slice traffic 316 has been determined by scheduler 325 to remain unchanged, for example, based on the detected congestion for that slice remaining below a reallocation threshold.)

Workflow 410 of FIG. 4B proceeds in a similar manner as workflow 400. In workflow 410, however, scheduler 365 receives a congestion notification from congestion model 380 based on ECN data from FWA traffic 312 and eMBB traffic 314.

Subsequent to its training based on historical ECN data 385, congestion model 380 may return a congestion forecast based on ECN data from slice traffic such as FWA traffic 312, eMBB traffic 314, and other slice traffic 316. The congestion forecast may include one or more metrics relating to ECN bit detections and/or network congestion. For example, the congestion forecast may include a predicted level or rate of change in ECN data or a predicted level or rate of change of network congestion based on the ECN data. For the sake of illustration, it will be assumed that congestion model 380 has determined in accordance with its training that network congestion has increased or is increasing for the eMBB slice. Upon receiving a congestion forecast from congestion model 380, scheduler 325 determines that network congestion has or is projected to exceed a threshold for reallocating radio resources 340 and proceeds with implementing a reallocation.

FIG. 5 illustrates exemplary wireless communication system 500 that serves wireless User Equipment (UE) 501. Wireless communication system 500 includes UE 501, Wifi Access Node (AN) 503, 5GNR RAN 505, Interworking Function (IWF) 535, Access and Mobility Management Function (AMF) 534, Authentication Server Function (AUSF) 531, Unified Data Management (UDM) 532, Policy Control Functions (PCFs) 533, Session Management Function (SMF) 536, User Plane Function (UPF) 537, Uniform Data Repository (UDR) 538, and Application Function (AF) 550. UDR 538 stores network data including subscriber profiles including identities, subscription details, service preferences, authentication credentials, and billing information. UDR 538 may also store policy data such as network rules, access rules, mobility rules, charging rules, and so on. AF 550 may provide policies applicable to control plane functions, that is, to the application, presentation, and/or session layers of the OSI protocol stack. IWF 535 includes non-3GPP IWFs (N3IWFs) for providing untrusted non-3GPP access to network data center 510, such as access via a non-cellular access network.

Continuing with wireless communication system 500, wireless network slice 540 includes UPF 537 and SMF 536. Wireless network slice 540 is representative of a dynamically allocated slice for hosting service from DN 560 to UE 501 according to the technology disclosed herein, including process 200 or workflow 400. Wireless network slice 540 (such as eMBB, FWA, URLLC, etc.) hosts traffic per the requirements of a QoS for the slice. DN 560 is representative of a data network, Internet access, third-party resource, or other endpoint of an end-to-end communication path from UE 501.

In an implementation, UE 501 communicates with network data center 510 via 5G-NR access node 505 or Wifi access node 503. UE 501 requests access to DN 560 via the communication network of network data center 510, e.g., via wireless network slice 540. RAN 505 determines an allocation or partitioning of radio resources for wireless communication with UE 501 and other devices according to the respective network slice based on congestion notifications embedded in packet headers of data to or from the device or other devices.

FIG. 6 illustrates computing device 601 that is representative of any system or collection of systems in which the various processes, programs, services, and scenarios disclosed herein may be implemented. Examples of computing device 601 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 601 may be implemented as a single apparatus, system, or device or may be implemented in a distributed manner as multiple apparatuses, systems, or devices. Computing device 601 includes, but is not limited to, processing system 602, storage system 603, software 605, communication interface system 607, and user interface system 609 (optional). Processing system 602 is operatively coupled with storage system 603, communication interface system 607, and user interface system 609.

Processing system 602 loads and executes software 605 from storage system 603. Software 605 includes and implements radio resource allocation process 606, which is (are) representative of the radio resource partitioning processes discussed with respect to the preceding Figures, such as process 200 and workflows 400, 410, and 420. When executed by processing system 602, software 605 directs processing system 602 to operate as described herein for at least the various processes, operational scenarios, and sequences discussed in the foregoing implementations. Computing device 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 include general purpose central processing units, graphical processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Software 605 (including radio resource partitioning process 606) may be implemented in program instructions and among other functions may, when executed by processing system 602, direct processing system 602 to operate as described with respect to the various operational scenarios, sequences, and processes illustrated herein. For example, software 605 may include program instructions for implementing a radio resource allocation process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing device 601 is representative) overall from a general-purpose computing system into a special-purpose computing system customized to support radio resource allocation in an optimized manner. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Unless the context clearly requires otherwise, throughout the description and the claims, the words "comprise," "comprising," “such as,” and “the like” are to be construed in an inclusive sense, as opposed to an exclusive or exhaustive sense, that is to say, in the sense of "including, but not limited to.” As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number respectively. The word "or," in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for," but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
process congestion data to detect a level of congestion in data traffic of a network slice carried by an access node of a wireless communication network;
determine that the level of congestion exceeds a threshold value for reallocating radio resources of the access node; and
reallocate the radio resources of the access node to provide additional carrying capacity for the data traffic of the network slice in response to determining that the level of congestion exceeds the threshold value.

2. The computing apparatus of claim 1, wherein the congestion data comprises Explicit Congestion Notification (ECN) bits comprising an ECN congestion notification in the data traffic of the network slice.

3. The computing apparatus of claim 2, wherein to process congestion data, the program instructions direct the computing apparatus to compute a metric based on a quantity of the ECN bits in the data traffic of the network slice.

4. The computing apparatus of claim 2, wherein to determine that the level of congestion exceeds the threshold value, the program instructions direct the computing apparatus to compute a first quantity of data traffic of the network slice comprising the ECN congestion notification relative to a second quantity of ECN-enabled data traffic of the network slice.

5. The computing apparatus of claim 1, wherein to reallocate the radio resources of the access node, the program instructions direct the computing apparatus to increase an allocation of bandwidth of the access node to the data traffic of the network slice.

6. The computing apparatus of claim 5, wherein the program instructions further direct the computing apparatus to process the congestion data to detect a second level of congestion in data traffic of a second network slice carried by the access node of the wireless communication network.

7. The computing apparatus of claim 6, wherein to reallocate the radio resources of the access node, the program instructions further direct the computing apparatus to decrease a second allocation of the bandwidth of the access node to the data traffic of the second network slice based on the second level of congestion.

8. A method of operating a computing device comprising:
processing congestion data to detect a level of congestion in data traffic of a network slice carried by an access node of a wireless communication network;
determining that the level of congestion exceeds a threshold value for reallocating radio resources of the access node; and
reallocating the radio resources of the access node to provide additional carrying capacity for the data traffic of the network slice based on determining that the level of congestion exceeds the threshold value.

9. The method of claim 8, wherein the congestion data comprises Explicit Congestion Notification (ECN) bits comprising an ECN congestion notification in the data traffic of the network slice.

10. The method of claim 9, wherein processing the congestion data comprises computing a metric based on a quantity of the ECN bits in the data traffic of the network slice.

11. The method of claim 9, wherein determining that the level of congestion exceeds the threshold value comprises computing a first quantity of the data traffic of the network slice comprising the ECN congestion notification relative to a second quantity of ECN-enabled data traffic of the network slice.

12. The method of claim 8, wherein reallocating the radio resources of the access node comprises increasing an allocation of bandwidth of the access node to the data traffic of the network slice.

13. The method of claim 12, further comprising detecting a second level of congestion in data traffic of a second network slice carried by the access node of the wireless communication network.

14. The method of claim 13, wherein reallocating the radio resources of the access node further comprises decreasing a second allocation of the bandwidth to the data traffic of the second network slice based on the second level of congestion.

15. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
detect congestion data of data traffic of network slices carried by an access node of a wireless communication network;
determine, based on the congestion data, that a level of congestion of a network slice of the network slices exceeds a threshold value; and
partition radio resources of the access node to the data traffic of the network slices based on determining that the level of congestion exceeds the threshold value.

16. The computing apparatus of claim 15, wherein the congestion data comprises Explicit Congestion Notification (ECN) bits comprising an ECN congestion notification.

17. The computing apparatus of claim 15, wherein to determine that the level of congestion of the network slice exceeds the threshold value, the program instructions direct the computing apparatus to determine that a quantity of ECN bits of ECN-enabled data traffic of the network slice exceeds the threshold value.

18. The computing apparatus of claim 15, wherein to partition the radio resources of the access node to the data traffic of the network slices, the program instructions direct the computing apparatus to allocate a bandwidth of the access node according to a type of the network slices.

19. The computing apparatus of claim 18, wherein the program instructions further direct the computing apparatus to determine, for a second network slice of the network slices, a second level of congestion based on the congestion data.

20. The computing apparatus of claim 19, wherein to allocate the bandwidth of the access node according to the type of network slices, the program instructions direct the computing apparatus to increase a first allocation of the bandwidth to data traffic of the network slice and to decrease a second allocation of the bandwidth to data traffic of the second network slice based on the level of congestion and the second level of congestion.
